(19) United States
(12) Patent Application Publication
(10) Pub. No.: US 2014/0281157 A1
(43) Pub. Date: Sep. 18, 2014

(54) MEMORY SYSTEM, MEMORY CONTROLLER AND METHOD

(71) Applicant: Kabushiki Kaisha Toshiba, Minato-ku (JP)

(72) Inventors: Daisuke Iwai, Kanagawa (JP); Hiroshi Yao, Kanagawa (JP); Hiroshi Sukegawa, Tokyo (JP); Yu Nakanishi, Kanagawa (JP)

(73) Assignee: Kabushiki Kaisha Toshiba, Minato-ku (JP)

(21) Appl. No.: 13/941,776

(22) Filed: Jul. 15, 2013

Related U.S. Application Data
(60) Provisional application No. 61/779,886, filed on Mar. 13, 2013.

(51) Int. Cl. G06F 12/02

(52) U.S. Cl. CPC G06F 12/0246
USPC 711/103

(57) ABSTRACT

According to one embodiment, a memory system includes a plurality of non-volatile memory chips and a memory controller. The memory controller controls a read operation of the memory chips, and manages correspondence relation information between a logical address included in a read command and a physical address of the memory chip. The memory controller causes at least two memory chips to store the same correspondence relation information. Further, in the read operation, the memory controller reads the correspondence relation information from at least one memory chip among the plurality of memory chips storing the same correspondence relation information.

### CROSS-REFERENCE TO RELATED APPLICATIONS

This application is based upon and claims the benefit of priority from U.S. Provisional Patent Application No. 61/779,886, filed on Mar. 13, 2013; the entire contents of which are incorporated herein by reference.

### FIELD

Embodiments described herein relate generally to a memory system, a controller and a method.

### BACKGROUND

In recent years, memory systems in which non-volatile semiconductor memory such as a NAND flash memory chip (hereinafter, referred to as a “NAND chip”) is mounted are attracting attention as a storage used in a computer system. The memory system holds a look up table (LUT) in which a correspondence relation between a logical address and a physical address is recorded thereinside. The memory system includes a controller that controls data transfer between a host and a NAND chip. The controller updates the LUT according to a change in the correspondence relation. The controller can specify a physical address of an access destination with reference to the LUT when the host makes an access request using a logical address.

### BRIEF DESCRIPTION OF THE DRAWINGS

FIG. 1 is a diagram illustrating a configuration example of a memory system according to a first embodiment.

FIG. 2 is a diagram illustrating a data structure example of LUT management information.

FIG. 3 is a flowchart for describing operation of a memory system when user data is written.

FIG. 4 is a flowchart for describing operation of the memory system according to the first embodiment when user data is read.

FIG. 5 is a flowchart for describing operation of a memory system according to a second embodiment when user data is read.

FIG. 6 is a flowchart for describing operation of a memory system according to a third embodiment when user data is read.

### DETAILED DESCRIPTION

In general, according to one embodiment, a memory system includes a plurality of non-volatile memory chips and a memory controller. The memory controller controls a read operation of the memory chips, and manages correspondence relation information between a logical address included in a read command and a physical address of the memory chip. The memory controller causes at least two memory chips to store the same correspondence relation information. Further, in the read operation, the memory controller reads the correspondence relation information from at least one memory chip among the plurality of memory chips storing the same correspondence relation information.

Exemplary embodiments of the memory system will be explained below in detail with reference to the accompanying drawings. The present invention is not limited to the following embodiments.

### First Embodiment

FIG. 1 is a diagram illustrating a configuration example of a memory system according to a first embodiment. A memory system 100 is connected with a host device (host) 200 such as a personal computer or a mobile terminal via a predetermined communication interface. An access command (a read command or a write command) that the memory system 100 receives from the host 200 includes a logical address LBA (Logical Block Addressing). As a communication interface standard, various communication interface standards such as serial advanced technology attachment (SATA), serial attached SCSI (SAS), PCI express (PCIe), and universal flash storage (UFS) can be employed.

The memory system 100 includes four memory chips 1a to 1d and a memory controller 10. The memory controller 10 includes a processing unit 2, a host interface (host I/F) 3, and a NAND controller (NANDC) 4. In the present embodiment, a NAND memory chip will be described as the memory chips 1a to 1d, but the memory chip is not limited to a NAND memory chip. The memory controller 10 controls a reading process (read operation) of performing reading from the memory chips 1a to 1d based on a read command input from the outside and a writing process of performing writing to the memory chips 1a to 1d based on a write command input from the outside. The memory controller 10 manages a correspondence relation between an LBA included in the read command and physical addresses of storage positions of the NAND chips 1a to 1d at which read data serving as a read target of the read command is stored.

The NAND chips 1a to 1d are labeled chip numbers #0 to #3, respectively. The number of NAND chips configuring the memory system 100 can be two or more. When the NAND chips 1a to 1d are collectively represented or when any one of the NAND chips 1a to 1d is represented, the NAND chips 1a to 1d may be referred to as a NAND chip 1.

The host I/F 3 controls a communication interface with the host 200. The host I/F 3 receives various commands output from the host 200, and performs transmission and reception of data with the host 200.

The NANDC 4 outputs various commands to the NAND chips 1a to 1d, and transfers data transferred from the NAND chips 1a to 1d to the processing unit 2. The NANDC 4 and the NAND chips 1a to 1d are connected with each other through an interconnection. One end of the interconnection is connected to the NANDC 4, and the other end thereof is branched into four, and branch destinations are connected to the NAND chips 1a to 1d, respectively. Examples of the interconnection include an I/O signal line and a control signal line. Examples of a control signal include a chip enable signal (CE), a command latch enable signal (CLE), an address latch enable signal (ALE), a write enable signal (WE), a read enable signal (RE), a write protect signal (WP), and a data strobe signal (DQS). The NANDC 4 detects operation statuses of the NAND chips 1a to 1d, and determines an output timing of a command according to the operation statuses of the NAND chips 1a to 1d. For example, the NAND chips 1a to 1d individually output a ready/busy signal (Ry/By) to the NANDC 4. The NANDC 4 receives the Ry/By from each of the NAND chips 1a to 1d, and checks whether each of the NAND chips 1a to 1d is in a ready status or a busy status. The NANDC 4 queues a command on the NAND chip 1 transferred from the processing unit 2. Then, when the NAND chip 1 of a destination of a command is in the ready status and the interconnection is idle, the NANDC 4 outputs the command, whereas when the NAND chip 1 of the destination of the command is in the busy status or when the interconnection is not idle, the NANDC 4 causes the output of the command to be on standby.

The NAND chip 1 has a storage region that holds data. The NAND chip 1 can store data (user data 13) on which the host 200 makes a write request. The storage region of the NAND chip 1 is configured with a memory cell array. The memory cell array is configured to include a plurality of blocks that are erasing units. Further, writing and reading on each block are executed in units of pages smaller than blocks.

An LUT 11 is stored in the NAND chip 1. Each of entries (LUT entries) configuring the LUT 11 is correspondence relation information between an LBA and a physical address of a storage region of the NAND chip 1. A NAND chip different form the NAND chip storing the LUT 11 stores an LUT 12 that is a copy of the LUT 11. In other words, the same LUT entry is stored in the two or more NAND chips. FIG. 1 illustrates an example in which the LUT 11 and the LUT 12 are separately managed, and the same LUT entry is stored in the two or more NAND chips. The LUT 11 is divided into four partial LUTs (LUTs #0 to #3), and the four partial LUTs are dispersedly stored in the different NAND chips 1. Each partial LUT includes one or more LUT entries. A method of dividing the LUT 11 is not limited to a specific method. Here, the LUT 11 is assumed to be divided such that the size of each partial LUT is equal to a block size. The number of divided partial LUTs is arbitrary. Further, the partial LUTs may be stored in the NAND chip 1 to be dispersed to all the NAND chips 1 as equally as possible. Further, a plurality of partial LUTs which are different for each NAND chip may be stored. Further, the whole LUT 11 may be stored in a single NAND chip without division.

The NAND chip 1 stores the LUT 12 that is a copy of the LUT 11. Similarly to the LUT 11, the LUT 12 is divided into four partial LUTs, and the four partial LUTs are dispersedly stored in different NAND chips 1. Here, as an example, each of the four partial LUTs configuring the LUT 12 is assumed to have a relation of a master and a copy with one of the four partial LUTs configuring the LUT 11. Further, a copy partial LUT is assumed to be stored in a NAND chip 1 whose chip number is one (1) larger than a NAND chip 1 storing a corresponding master partial LUT. Further, a method of selecting the NAND chips 1 that are to store the master partial LUT and the copy partial LUT is arbitrary as long as a partial LUT having the same content is stored in a plurality of different NAND chips 1. Further, when the entire LUT 11 is stored in a single NAND chip without division, the LUT 12 is not divided and stored in a NAND chip different from a NAND chip storing the LUT 11.

Further, a system region and a user region may be defined in each of the NAND chips 1a to 1d in advance, and the LUT 11 and the LUT 12 may be stored in the system region, and the user data 13 may be stored in the user region.

The processing unit 2 can control data transfer between the host 200 and the NAND chip 1 by controlling the host I/F 3 and the NANDC 4. The processing unit 2 includes an address resolution unit 21, a data transferring unit 22, an LUT cache 23, and a storage unit 24. The storage unit 24 stores LUT management information 25.

For example, the components of the processing unit 2 are implemented by executing a firmware program through an arithmetic and logic device in a computer including the arithmetic and logic device and a storage device storing the firmware program in advance. For example, the LUT cache 23 and the storage unit 24 may be configured using DRAM, FeRAM, SRAM, MRAM, or a combination thereof. All or some components of the processing unit 2 may be implemented by a hardware circuit such as an ASIC.

The LUT management information 25 is a table in which a correspondence relation between an LBA and a storage position of an LUT entry in the NAND chip 1 is described. The LUT entry configuring the LUT 11 associates an LBA with a physical address of a storage region of the NAND chip 1 for each predetermined unit size (for example, for each page size). In order to reduce the size of the LUT management information 25, a storage position of an LUT entry may be described in the LUT management information 25 for every two or more LUT entries in which LBAs are consecutive to each other. As the size of the LUT management information 25 decreases, the size of the storage device disposed in the processing unit 2 also decreases. Thus, when a storage device is configured with, for example, SRAM more expensive than DRAM, the cost can be reduced. Here, as an example, each partial LUT is assumed to be configured with a plurality of LUT entries in which LBAs are consecutive to each other, and the LUT management information 25 is assumed to represent a storage position of the LUT 11 for each partial LUT. Further, a management unit of the LUT management information 25 may not match a unit of the partial LUT.

FIG. 2 is a diagram illustrating a data structure example of the LUT management information 25. As illustrated in FIG. 2, the LUT management information 25 has a table structure in which a correspondence between an LBA and a beginning physical address of the partial LUT is registered for each partial LUT. In FIG. 2, physical addresses of storage destinations of pages are stored in rectangular regions (regions indicated by the reference numeral 111 in FIG. 2) configuring the LUT #0, respectively, in the arrangement order of the LBAs. A relative position of the region 111 from the beginning of the LUT #0 corresponds to an offset amount obtained by subtracting an LBA registered in the LUT management information 25 from an LBA on which an access request is made.

The LUT cache 23 caches a used LUT entry.

When a read request is made by the host 200, the address resolution unit 21 calculates a physical address corresponding to an LBA on which the read request is made. In other words, the address resolution unit 21 executes the address resolution. At the time of address resolution, the address resolution unit 21 uses the LUT cache 23. When a cache miss occurred in the LUT cache 23, the address resolution unit 21 specifies a physical address of a storage destination of an LUT entry with reference to the LUT management information 25, and reads a physical address corresponding to an LBA from the specified physical address.

FIG. 3 is a flowchart for describing operation of the memory system 100 when the user data 13 is written.

First of all, the data transferring unit 22 writes the user data 13 to the NAND chip 1 (S1). More specifically, the process of step S1 is executed as follows. First of all, the address resolution unit 21 determines a physical address of a writing destination. A method of determining a physical address is arbitrary. For example, the address resolution unit 21 stores the number of rewriting times for each block, and determines a block of a writing destination such that all blocks become almost equal in the number of rewriting times. Then, the address resolution unit 21 determines a physical address of a non-written page in a block of a writing destination as a physical address of a writing destination. Further, when there is a block having a non-written page, the address resolution unit 21 may determine a physical address of the non-written page in the corresponding block as the physical address of the writing destination. The data transferring unit 22 designates the determined physical address, and transfers the write command to the NANDC 4. The NANDC 4 queues the received command. Then, when the NAND chip 1 of the writing destination is in the ready status and the interconnection is idle, the queued write command is transferred to the NAND chip 1 of the writing destination. The NAND chip 1 of the writing destination writes the user data 13 included in the transferred write command at the position represented by the physical address of the writing destination. The NAND chip 1 of the writing destination remains in the busy status until writing is completed after the write command is received.

Subsequently to the process of step S1, the address resolution unit 21 updates the LUT cache 23 (S2). Specifically, the address resolution unit 21 associates the physical address determined as the writing destination in step S1 with an LBA, and causes the association result to be cashed in the LUT cache 23.

Here, when another LUT entry is cached in a corresponding cache line and the corresponding cache line is dirty, a cache overflow occurs in the LUT cache 23. When it is determined in the process of step S2 that the cache overflow has occurred in the LUT cache 23 (Yes in S3), the address resolution unit 21 writes back the overflowed entry in a plurality of NAND chips 1 (S4), and then the operation ends. When it is determined that the cache overflow has not occurred (No in S3), the address resolution unit 21 skips the process of step S4.

Further, in the process of step S4, first, the address resolution unit 21 executes writing-back on the LUT 11. Then, the address resolution unit 21 writes the same content as the content written back to the LUT 11 to the LUT 12. Further, as writing back is performed on the LUT 11, the address resolution unit 21 updates the LUT management information 25. Further, a relative position of a writing position on a copy partial. LUT from a writing position on a master partial LUT is assumed to be a predetermined fixed value. The fixed value is assumed to be set in advance so that a copy having the same content as the master partial LUT is constantly stored in the NAND chip 1 having a chip number obtained by adding one (1) to a chip number of the NAND chip 1 storing the master partial LUT. Thus, since information of a writing position on the LUT 12 can be obtained by a calculation, it is unnecessary to hold the writing information on the LUT 12 in the LUT management information 25. In other words, the address resolution unit 21 adds the fixed value to the write-back position on the LUT 11 and specifies the writing position on the LUT 12 having the same content as the written-back content.

FIG. 4 is a flowchart for describing operation of the memory system 100 when the user data 13 is read.

First of all, the address resolution unit 21 refers to the LUT cache 23 using an LBA included in the read command (S11). When it is determined that a cache hit has occurred in the LUT cache 23 (Yes in S12), the address resolution unit 21 acquires a physical address of a storage position of the NAND memory 1 storing read data that is a read target of the read command (S13). Here, the cache hit means that an LUT entry on an LBA included in the read command is cached in the LUT cache 23, and the LUT cache 23 returns the corresponding LUT entry. Then, the data transferring unit 22 reads the user data 13 using the acquired physical address (S14), and then the operation ends.

When it is determined that a cache miss has occurred in the LUT cache 23 (No in S12), the address resolution unit 21 specifies a physical address in which an LUT entry (here, an LUT entry included in the LUT 11) is stored according to the reading destination with reference to the LUT management information 25 (S15). Here, the cache miss represents that an LUT entry according to an LBA included in the read command is found out not to be cached in the LUT cache 23. Then, the address resolution unit 21 determines whether or not the NAND chip 1 (that is, the NAND chip 1 storing the master LUT entry) having the physical address specified by the process of step S15 is in the ready status (S16). For example, the process of step S16 is implemented such that the address resolution unit 21 transmits an inquiry to the NANDC 4. When it is determined that the NAND chip 1 is in the ready status (Yes in S16), the address resolution unit 21 reads an LUT entry from the NAND chip 1 using the physical address specified by the process of step S15 as a physical address of the reading destination (S17).

When it is determined that the NAND chip 1 is in the busy status (No in S16), the address resolution unit 21 determines whether or not the NAND chip 1 storing the copy LUT entry is in the ready status (S18). The NAND chip 1 storing the copy LUT entry is the NAND chip 1 whose chip number is one larger than the chip number of the NAND chip 1 storing the master LUT entry. When it is determined that the NAND chip 1 storing the copy LUT entry is in the busy status (No in S18), the address resolution unit 21 executes the process of step S16 again.

When it is determined that the NAND chip 1 storing the copy LUT entry is in the ready status (Yes in S18), the address resolution unit 21 calculates a physical address at which a copy of the copy LUT entry is stored (S19), and reads an LUT entry as using the calculated physical address as the reading destination (S20). After the process of step S17 or the process of step S20, the data transferring unit 22 causes the process to proceed to step S14, and reads the user data 13 from the NAND chip 1 using the physical address acquired by the process of step S17 or the process of step S20 as the physical address of the reading destination.

In the above description, the LUT entry is duplexed, but the LUT entry may be multiplexed into three or more. When the LUT entry is multiplexed into three or more, a master and two or more copies of the LUT entry may be stored in different NAND memories 1, respectively.

Further, as a physical address of a storage position of a copy of an LUT entry is calculated from a physical address of a storage position of a master of an LUT entry, the size of the LUT management information 25 is reduced, but a physical address of a storage position of a copy of an LUT entry may be managed through the LUT management information 25.

As described above, according to the first embodiment, the address resolution unit 21 causes the LUT entries having the same content to be stored in a plurality of different NAND chips 1. Further, in the reading process of the user data 13, the address resolution unit 21 reads an LUT entry from any one of a plurality of NAND chips 1 storing an LUT entry in which a correspondence relation between an LBA on which a read request is made from the outside and a physical address is described, and specifies a physical address of a storage position of the user data 13 using the read LUT entry. Thus, the memory system 100 can select the NAND chip 1 in the ready status from among a plurality of the NAND chips 1 storing the LUT entry having the same content and read the LUT entry, and thus it is possible to suppress a decrease in a reading speed that is caused by a reading collision. In other words, the reading speed of the user data is improved.

Further, the address resolution unit 21 selects the NAND chip 1 in the ready status from among a plurality of memory chips storing the LUT entry having the same content as the reading target of the LUT entry. Thus, the speed of the address resolution can be increased. In other words, the reading speed of the user data is improved.

### Second Embodiment

An LUT entry is frequently read. However, in a NAND-type memory cell array, when reading is repeatedly executed on the same position, a probability of a reading error is likely to increase due to a read disturb. According to a second embodiment, an LUT entry to be actually read is randomly selected among LUT entries that are arranged to be multiplexed into a plurality of NAND chips. Thus, a wear degree of a NAND chip is planarized. The second embodiment will be described using the same names and reference numerals as the memory system according to the first embodiment.

In the second embodiment, an LUT entry is assumed to be multiplexed into three. That is, a redundancy degree is “3.” Specifically, when a master LUT entry is stored in a NAND chip 1 of a chip #i, a copy of the master LUT entry is stored in a NAND chip 1 of a chip #i+1 and a NAND chip 1 of a chip #i+2.

FIG. 5 is a flowchart for describing operation of a memory system 100 according to the second embodiment when the user data 13 is read.

First of all, steps S31 to S36 are executed by the same process as in steps S11 to S16. When it is determined in the determination process of step S36 that the NAND chip 1 storing the master LUT entry is in the ready status (Yes in S36), the address resolution unit 21 reads an LUT entry using the physical address specified by the process of step S35 as the physical address of the reading destination (S37).

When it is determined that the NAND chip 1 storing the master LUT entry is in the busy status (No in S36), the address resolution unit 21 acquires a random number (S38). For example, a timer counter value operating by a system clock may be used as a random number. Then, the address resolution unit 21 calculates a remainder by dividing the acquired random number by the redundancy degree (here, “3”) (S39). Then, the address resolution unit 21 selects the NAND chip 1 whose chip number is larger than the NAND chip 1 storing the master LUT entry by the calculated remainder (S40), and determines whether or not the selected NAND chip 1 is in the ready status (S41). When it is determined that the selected NAND chip 1 is in the busy status (No in S41), the address resolution unit 21 executes the process of step S38 again.

When it is determined that the selected NAND chip 1 is in the ready status (Yes in S41), the address resolution unit 21 calculates a physical address at which a copy of an LUT entry of a reading target is stored (S42), and reads an LUT entry using the calculated physical address as the physical address of the reading destination (S43). After the process of step S37 or the process of step S43, in the process of step S34, the data transferring unit 22 reads the user data 13 from the NAND chip 1 using the physical address acquired by the process of step S37 or the process of step S43 as the physical address of the reading destination.

The above description has been made in connection with the example in which the copy LUT entry is randomly selected when the NAND chip 1 storing the master LUT entry is in the busy status. However, before it is determined whether or not the NAND chip 1 storing the master LUT entry is in the ready status, the reading target may be selected based on the random number from among the NAND chips 1 that store the same LUT entries including a master and a copy and are in the ready status.

As described above, according to the second embodiment, the address resolution unit 21 randomly selects the NAND chip 1 that is the reading target of the LUT entry from among a plurality of NAND chips 1 in the ready status when there are a plurality of NAND chips 1 in the ready status among a plurality of memory chips storing the LUT entry having the same content. Thus, in a storage region storing an LUT entry, the number of reading times on the same position can be reduced, and thus deterioration of the memory cell array caused due to the read disturb can be suppressed.

### Third Embodiment

In the first and second embodiments, the read command is output to one of the NAND chips 1 storing the multiplexed LUT entries. On the other hand, in a third embodiment, the read command is output to all of the NAND chips 1 storing the master LUT entry and the copy LUT entry. A process by which the read command is output to all of the NAND chips 1 storing the master LUT entry and the copy LUT entry, and the LUT entry is read is referred to as a multiplexing reading process. The address resolution is performed using an LUT entry that is read fastest when the multiplexing reading process is performed.

Further, when the multiplexing reading process is executed at each read request input from the outside, the reading speed decreases. In this regard, in the third embodiment, the memory system 100 is assumed to execute the multiplexing reading process only when an instruction for referential reading is given from the host 200.

For example, when the universal flash storage (UFS) standard is applied as the communication interface standard of the memory system 100, the host 200 may include an instruction (a high priority instruction) to execute preferential reading in the read command. In the memory system 100, a queue for accumulating commands from the host 200 is disposed in the host I/F 3, and the processing unit 2 executes the commands accumulated in the queue from the beginning. Here, when a command having a high priority instruction is received, the host I/F 3 can cause the command to be stored in the queue at the beginning. Thus, the memory system 100 can deal with the read command having the high priority instruction more preferentially than other commands.

FIG. 6 is a flowchart for describing operation of the memory system 100 according to the third embodiment when the user data 13 is read.

First of all, steps S51 to S54 are executed by the same process as in steps S11 to S14.

When it is determined that a cache miss has occurred in the LUT cache 23 (No in S52), the address resolution unit 21 determines whether or not the high priority instruction is included in the read command input from the host 200 (S55). When it is determined that the high priority instruction is not included in the read command input from the host 200 (No in S55), in steps S56 to S61, the same process as in steps S15 to S20 is executed.

When it is determined that the high priority instruction is included in the read command input from the host 200 (Yes in S55), the address resolution unit 21 executes the multiplexing reading process. In other words, the address resolution unit 21 calculates all physical addresses storing the copy LUT entry (S62). Then, the address resolution unit 21 specifies one or more NAND chips 1 in the ready status among three NAND chips 1 storing the master LUT entry and the copy LUT entry (S63). Then, the address resolution unit 21 outputs the read command on the NAND chip 1 to one or more specified NAND chips 1 using the physical address specified by the process of step S62 as the physical address of the reading destination (S64). Thereafter, the data transferring unit 22 acquires a physical address from an LUT entry that is read fastest after the process of step S64 (S65), and in the process of step S54, the user data 13 is read from the NAND chip 1 using the physical address acquired in the process of step S65 as the reading destination.

As described above, according to the third embodiment, the address resolution unit 21 executes LUT entry reading on a plurality of NAND chips 1 storing the same LUT entry in parallel, and specifies a physical address of a storage position of the user data 13 using the LUT entry that is read fastest. When there is a variation in the reading speed between the NAND chips 1 due to a manufacturing variation of the NAND chip 1, an LUT entry read from the NAND chip 1 that is fastest in the reading speed is used. Thus, the speed taken for the address resolution is further improved, and thus the user data reading speed is further improved.

The first to third embodiments have been described in connection with the example in which the address resolution is executed using the multiplexed LUT entry when the memory system 100 reads the user data 13 according to the read command from the host 200. For example, the memory system 100 may execute the address resolution using the multiplexed LUT entry even when the user data 13 is read inside the memory system 100 such as a compaction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system, comprising:
a plurality of non-volatile memory chips; and
a memory controller that controls a read operation of the memory chips, and manages correspondence relation information between a logical address included in a read command and a physical address of the memory chip, the memory controller causing at least two memory chips to store the same correspondence relation information,
wherein the memory controller, in the read operation, reads the correspondence relation information from at least one memory chip among the plurality of memory chips storing the same correspondence relation information.

2. The memory system according to claim 1,
wherein the memory controller reads the correspondence relation information from a memory chip in a ready status among the memory chips storing the same correspondence relation information.

3. The memory system according to claim 1,
wherein when more than two memory chips are in a ready status among the memory chips storing the same correspondence relation information, the memory controller reads the correspondence relation information from a memory chip selected based on a random number.

4. The memory system according to claim 1,
wherein the memory controller reads the correspondence relation information from more than two memory chips storing the same correspondence relation information in parallel, uses correspondence relation information that is read fastest.

5. The memory system according to claim 1,
wherein the read operation is performed based on the read command from the outside of the memory system.

6. The memory system according to claim 1,
wherein the read operation is performed based on compaction operation inside the memory system.

7. The memory system according to claim 1,
wherein the memory controller includes a cache memory storing the correspondence relation information, and periodically writes the correspondence relation information stored in the cache memory to more than two memory chips.

8. A memory controller connected to a plurality of non-volatile memory chips, comprising:
the controller controls a read operation of the memory chips, and manages correspondence relation information between a logical address included in a read command and a physical address of the memory chip,
wherein
the memory controller causes at least two memory chips to store the same correspondence relation information, and
the memory controller, in the read operation, reads the correspondence relation information from at least one memory chip among the plurality of memory chips storing the same correspondence relation information.

9. The memory controller according to claim 8,
wherein the memory controller reads the correspondence relation information from a memory chip in a ready status among the memory chips storing the same correspondence relation information.

10. The memory controller according to claim 8,
wherein when more than two memory chips are in a ready status among the memory chips storing the same correspondence relation information, the memory controller reads the correspondence relation information from a memory chip selected based on a random number.

11. The memory controller according to claim 8,
wherein the memory controller reads the correspondence relation information from more than two memory chips storing the same correspondence relation information in parallel, uses correspondence relation information that is read fastest.

12. The memory controller according to claim 8,
wherein the read operation is performed based on the read command from the outside.

13. The memory controller according to claim 8,
Wherein
the memory controller executes compaction operation, and
the read operation is performed based on the compaction operation.

14. The memory controller according to claim 8, further comprising
a cache memory storing the correspondence relation information,
wherein the memory controller periodically writes the correspondence relation information stored in the cache memory to more than two memory chips.

15. A method of managing a plurality of non-volatile memory chips by a memory controller, comprising:
controlling, by the memory controller, a read operation of the memory chips; and
managing, by the memory controller, correspondence relation information between a logical address included in a read command and a physical address of the memory chip,
wherein
the managing includes
causing at least two memory chips to store the same correspondence relation information, and
in the read operation, reading the correspondence relation information from at least one memory chip among the plurality of memory chips storing the same correspondence relation information.

16. The method according to claim 15, further comprising
reading, by the memory controller, the correspondence relation information from a memory chip in a ready status among the memory chips storing the same correspondence relation information.

17. The method according to claim 15, further comprising
when more than two memory chips are in a ready status among the memory chips storing the same correspondence relation information, reading, by the memory controller, the correspondence relation information from a memory chip selected based on a random number.

18. The method according to claim 15, further comprising:
by the memory controller,
reading the correspondence relation information from more than two memory chips storing the same correspondence relation information in parallel; and
using correspondence relation information that is read fastest.

19. The method according to claim 15,
wherein the read operation is performed based on the read command from the outside.

20. The method according to claim 15, further comprising
executing, by the memory controller, compaction operation,
wherein
the read operation is performed based on the compaction operation.

21. The method according to claim 15,
wherein the memory controller includes a cache memory storing the correspondence relation information, and
the method further comprises, periodically writing, by the memory controller, the correspondence relation information stored in the cache memory to more than two memory chips.
